(19) United States
(12) Patent Application Publication
(10) Pub. No.: US 2019/0253904 A1
(43) Pub. Date: Aug. 15, 2019

(54) DOWNLINK CHANNEL RECEPTION IN WIRELESS COMMUNICATION SYSTEM

(71) Applicant: MEDIATEK INC., Hsinchu (TW)

(72) Inventors: Cheng-Rung Tsai, Hsinchu (TW); Chia-Hao Yu, Hsinchu (TW); Jiann-Ching Guey, Hsinchu (TW)

(73) Assignee: MEDIATEK INC., Hsinchu (TW)

(21) Appl. No.: 16/260,922

(22) Filed: Jan. 29, 2019

Related U.S. Application Data
(60) Provisional application No. 62/628,317, filed on Feb. 9, 2018.

(51) Int. Cl. H04W 24/08; H04W 16/14; H04W 72/04; H04W 80/02; H04W 76/27

(52) U.S. Cl. CPC H04W 24/08; H04W 16/14; H04W 72/046; H04L 5/001; H04W 80/02; H04W 76/27; H04W 72/0446

(57) ABSTRACT

Aspects of the disclosure provide a method for reception of simultaneously transmitted downlink channels having different spatial quasi-co-location (sQCL) assumptions. The method can include receiving a configuration specifying a control resource set (CORESET) monitoring occasion of a first physical downlink control channel (PDCCH) at a user equipment (UE), receiving a second PDCCH scheduling or activating transmission of a physical downlink shared channel (PDSCH) at the UE, determining whether the PDSCH overlaps the first PDCCH in time domain, determining whether a first spatial quasi-co-location (sQCL) assumption for reception of the first PDCCH and a second sQCL assumption for reception of the PDSCH are different, and prioritizing the reception of the first PDCCH when the PDSCH overlaps the first PDCCH in time domain and the first and second sQCL assumptions are different.

### INCORPORATION BY REFERENCE

This present disclosure claims the benefit of U.S. Provisional Application No. 62/628,317, “Mechanisms for Differential L1-RSRP Reporting” filed on Feb. 9, 2018, which is incorporated herein by reference in its entirety.

### TECHNICAL FIELD

The present disclosure relates to wireless communications, and specifically relates to downlink channel reception in a beamformed wireless communication system.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

5G New Radio (NR) radio-access technology supports beamformed transmission and reception to extend coverage at higher-frequency bands. A mobile device may implement analog beamforming where the beam is shaped after digital-to-analog conversion. In an example, analog beamforming results in a constraint that a transmit or receive beam can only be formed at one direction at a given time instant. A base station may signal an indication to the device to assist selection of a receive beam to be used for downlink data or control reception.

### SUMMARY

Aspects of the disclosure provide a method for reception of simultaneously transmitted downlink channels having different spatial quasi-co-location (sQCL) assumptions. The method can include receiving a configuration specifying a control resource set (CORESET) monitoring occasion of a first physical downlink control channel (PDCCH) at a user equipment (UE), receiving a second PDCCH scheduling or activating transmission of a physical downlink shared channel (PDSCH) at the UE, determining whether the PDSCH overlaps the first PDCCH in time domain, determining whether a first spatial quasi-co-location (sQCL) assumption for reception of the first PDCCH and a second sQCL assumption for reception of the PDSCH are different, and prioritizing the reception of the first PDCCH when the PDSCH overlaps the first PDCCH in time domain and the first and second sQCL assumptions are different.

In an embodiment, prioritizing the reception of the first PDCCH includes performing the reception of the first PDCCH according to the first sQCL assumption for reception of the first PDCCH. In an embodiment, performing the reception of the first PDCCH according to the first sQCL assumption includes monitoring a CORESET carrying the first PDCCH using a spatial filter associated with a reference signal (RS) indicated by the first sQCL assumption.

In an embodiment, the first sQCL indication is determined based on a transmission configuration indication (TCI) state carried in a radio resource control (RRC) message or a MAC control element (CE). In an embodiment, the second sQCL assumption is determined based on a TCI state carried in a MAC CE or a second PDCCH scheduling the PDSCH.

In an embodiment, the method can further includes determining whether the PDSCH overlaps the first PDCCH in time domain according to the received configuration specifying the CORESET monitoring occasion of the first PDCCH and the received second PDCCH scheduling the transmission of the PDSCH, or according to the received configuration specifying the CORESET monitoring occasion of the first PDCCH and the second PDCCH and a second configuration received at the UE specifying a periodicity of a sequence of semi-persistently scheduled (SPS) PDSCHs that includes the PDSCH activated by the second PDCCH.

In an embodiment, the method can further includes when a time offset between reception of the second PDCCH and reception of the PDSCH is smaller than a threshold, using a sQCL assumption for the reception of a PDCCH, that is carried in a CORESET with the lowest CORESET-ID in a latest slot in which one or more CORESETs within an active bandwidth part (BWP) of a serving cell are monitored by the UE, as the second sQCL assumption for reception of the PDSCH, and when the time offset between the reception of the second PDCCH and the reception of the PDSCH is greater than or equal to the threshold, using a sQCL assumption indicated by a second sQCL indication carried in the second PDCCH as the second sQCL assumption for the reception of the PDSCH.

In an embodiment, the first PDCCH and the PDSCH are transmitted over two different component carriers in an intra-band carrier aggregation configuration, or over a same component carrier.

Aspects of the disclosure further provide a user equipment (UE). The UE includes circuitry configured to receive a configuration specifying a control resource set (CORESET) monitoring occasion of a first physical downlink control channel (PDCCH) at a user equipment (UE), receive a second PDCCH scheduling or activating transmission of a physical downlink shared channel (PDSCH) at the UE, determine whether the PDSCH overlaps the first PDCCH in time domain, determine whether a first spatial quasi-co-location (sQCL) assumption for reception of the first PDCCH and a second sQCL assumption for reception of the PDSCH are different, and prioritize the reception of the first PDCCH when the PDSCH overlaps the first PDCCH in time domain and the first and second sQCL assumptions are different.

Aspects of the disclosure further provide a non-transitory computer-readable medium storing instructions implementing the method for reception of simultaneously transmitted downlink channels having different sQCL assumptions

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a beam-based wireless communication system according to some embodiments of the disclosure;

FIG. 2 shows an example illustrating reception of downlink data or control transmissions based on spatial quasi-co-location (sQCL) indications signaled from a base station (BS) to a user equipment (UE) according to an embodiment;

FIG. 3 shows an example process for reception of simultaneously transmitted physical downlink control channel (PDCCH) and physical downlink shared channel (PDSCH) that have different sQCL assumptions according to an embodiment of the disclosure; and

FIG. 4 shows an exemplary apparatus according to embodiments of the disclosure.

### DETAILED DESCRIPTION OF EMBODIMENTS

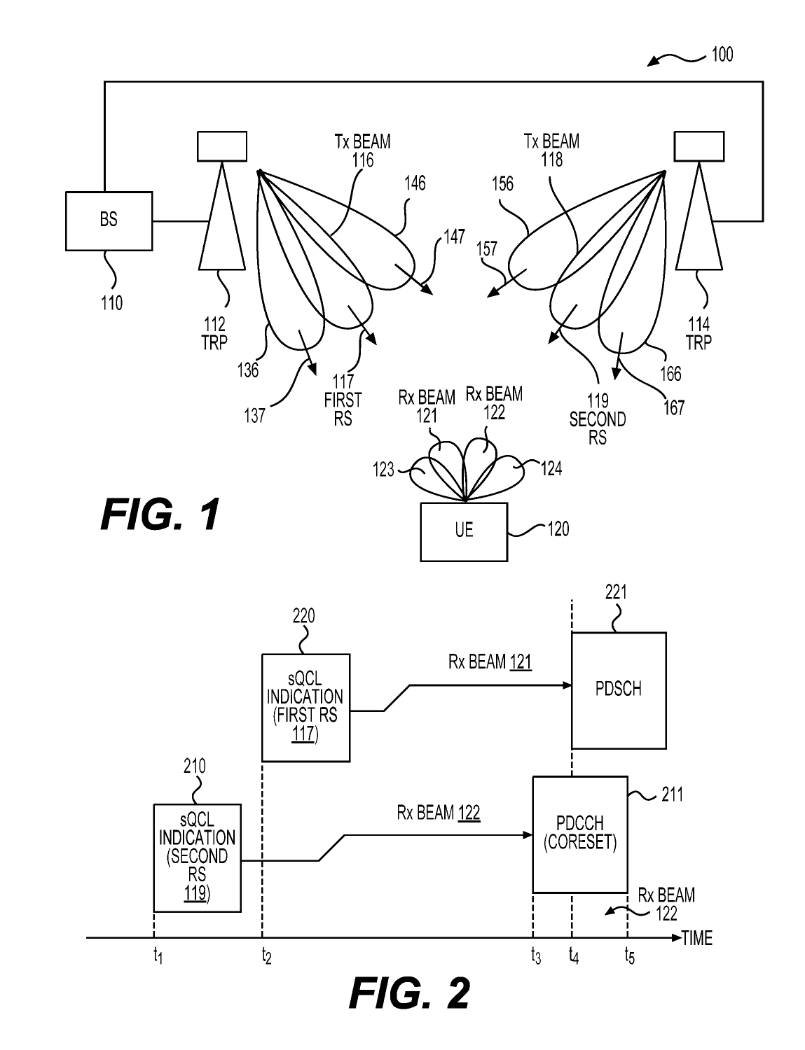

FIG. 1 shows a beam-based wireless communication system 100 according to some embodiments of the disclosure. The system 100 can include a base station (BS) 110, two transmission reception points (TRPs) 112 and 114 connected with the BS 110, and a user equipment (UE) 120. In an embodiment, the system 100 can employ the 5th generation (5G) technologies developed by the 3rd Generation Partnership Project (3GPP). For example, orthogonal frequency-division multiplexing (OFDM) scheme is employed for downlink and uplink transmission. In addition, millimeter Wave (mm-Wave) frequency bands and beamforming technologies can be employed in the system 100. Accordingly, the BS 110 and the UE 120 can perform beamformed transmission or reception. In beamformed transmission, wireless signal energy can be focused on a specific direction to cover a target serving region. As a result, an increased antenna transmission (Tx) gain can be achieved in contrast to omnidirectional antenna transmission. Similarly, in beamformed reception, wireless signal energy received from a specific direction can be combined to obtain a higher antenna reception (Rx) gain in contrast to omnidirectional antenna reception. The increased Tx or Rx gain can compensate path loss or penetration loss in mm-Wave signal transmission.

In an embodiment, the BS 110 implements a gNB node as specified in 5G New Radio (NR) air interface standards developed by 3GPP. The BS 110 can be configured to control one or more TRPs, such as the TRPs 112 and 114, that are distributed at different locations to cover different serving areas. Each TRP can include a set of antenna arrays. Under the control of the BS 110, directional Tx or Rx beams can be formed from the set of antenna arrays for transmitting or receiving wireless signals. In an example, the maximum number of Tx beams generated from a TRP can be 64. In an embodiment, multiple Tx beams towards different directions are generated simultaneously. In an embodiment, only one Tx beam is generated at a given time. Over each Tx beam, downlink L1/L2 control channel or data channel, such as a physical downlink control channel (PDCCH) or a physical downlink shared channel (PDSCH), can be transmitted.

The UE 120 can be a mobile phone, a laptop computer, a vehicle carried mobile communication device, a utility meter, and the like in various embodiments. Similarly, the UE 110 can employ one or more antenna arrays to generate directional Tx or Rx beams for transmitting or receiving wireless signals. In an embodiment, the UE 120's beamforming capability is limited to forming only one Rx beam towards one direction at a given time due to the implementation of the UE 120. In other words, the UE 120 is not capable of forming multiple Rx beams towards different directions at a same time. For example, the UE 120 implements analog beamforming in an embodiment. A Rx spatial filter is used to process received signals before an analog-to-digital conversion of the received signals. For example, by employing the Rx spatial filter, different phase shifts can be imposed over the signals received from individual antennas of an antenna array such that the signals received from a specific direction can be constructively combined. The analog beamforming results in the limitation that only one Rx beam, that corresponds to a Rx spatial filter, can be formed at one direction at a given time instant.

In an embodiment, the UE 120 determines a Rx beam (or a Rx spatial filter) among multiple Rx beams for receiving signals from a TRP according to a measurement of a reference signal (RS). For example, while the UE 120 is in connected mode, a beam quality monitoring process can be repeatedly carried out in an embodiment. During the process, based on a configuration received from the BS 110, the UE 120 may periodically measure signal qualities of a set of beam pair links formed between a set of Tx beams of the TRP 112 and a set of Rx beams of the UE 120. For example, a set of RSs 137, 117, 147, 157, 119, and 167 are transmitted from over a set of Tx beams 136, 116, 146, 156, 118, and 166 (e.g., with a set of Tx spatial filters) of the TRP 112 and the TRP 114. RSRPs, for example, can be measured based on the set of RSs 137, 117, 147, 157, 119, and 167 received by a set of Rx beams 123, 121, 122, and 124 (e.g., with a set of Rx spatial filters) of the UE 120. Base on the measurement results, the UE 120 can determine a subset of the RSs 137, 117, 147, 157, 119, and 167 with good qualities (e.g., above a threshold) and report them to the BS 110. At the network side, the BS 110 can determine, for example, the first RS 117 of the TRP 112 for transmitting signals to the UE 120 based the reported RSs from the UE 120, where the first RS 117 is transmitted over the Tx beam 116 of the TRP 112 and received by the Rx beam 121 of the UE 120. The Rx beam 121 and the Tx beam 116 are thus associated with first RS 117.

In a similar way, the second RS 119 transmitted by the Tx beam 118 of the TRP 114 and received by the Rx beam 122 of the UE 120 can be determined based on the reported RSs from the UE 120. As a result, the Rx beam 122 and the Tx beam 118 are associated with second RS 119.

As described above, the BS 110 can have multiple options of selecting a Tx beam for a transmission to the UE 110. For example, the BS 110 can transmit an L1/L2 data channel or control channel over either of the Tx beams 116 or 118. Accordingly, the BS 110 can signaling a Rx configuration to the UE 120 to indicate a Rx beam for reception of a to-be-conducted transmission from the BS 110 to the UE 120 in an embodiment. The indicated Rx beam corresponds to the Tx beam selected among the Tx beams 116 and 118. The signaling can be performed via one of multiple ways, such as a radio resource control (RRC) message, a MAC layer control element (CE), a field of a downlink control information (DCI) carried in a PDCCH, and the like.

In an embodiment, a Rx configuration is provided to the UE 120 by signaling a quasi-co-location (QCL) indication (or QCL assumption) to the UE 120 in order to indicate a Rx beam for reception of a downlink transmission. The QCL indication can indicate an antenna port or multiple antenna ports for the downlink transmission is QCLed with an antenna port for transmission of an RS (e.g., a channel station information reference signal (CSI-RS)) with respect to spatial Rx parameter. In other words, the QCL indication indicates that the UE 120 can use a same Rx beam (or Rx spatial filter) for reception of the indicated RS to receive the downlink transmission.

Based on the RS indicated by the QCL indication (or QCL assumption), the UE 120 can assume that the antenna port for the downlink transmission is QCLed with the antenna port for transmission of the indicated RS with respect to the indicated spatial Rx parameter. Accordingly, the UE 120 can determine to use a respective Rx beam obtained based on a measurement of the indicated RS to perform the reception of the downlink transmission. The above QCL relationship in terms of spatial Rx parameter is referred to as a spatial QCL (sQCL). The corresponding QCL indication indicating such a sQCL is referred to as a sQCL indication. According to a sQCL indication, the UE 120 can obtain a sQCL assumption.

In an embodiment, the QCL indication is provided from the BS 110 to the UE 120 by way of signaling a transmission configuration indication (TCI) state for reception of a to-be-transmitted downlink data or control channel. For example, a list of TCI state configurations can be configured to the UE 120 through a higher layer parameter via an RRC signaling. Each TCI state indicates an RS and a QCL type for configuring a QCL relationship of the indicated QCL type between antenna ports of the RS and a demodulation reference signal (DM-RS) of a to-be-transmitted channel to which the TCI state is configured. For example, the QCL type between the RS and the DM-RS can be one of the following:

QCL-TypeA: {Doppler shift, Doppler spread, average delay, delay spread},

QCL-TypeB: {Doppler shift, Doppler spread},

QCL-TypeC: {Average delay, Doppler shift},

QCL-TypeD: {Spatial Rx parameter}.

Thus, when a TCI state is configured to the UE 120 for reception of a PDCCH or a PDSCH, a QCL type of the DM-RS of the PDCCH or PDSCH can be conveyed to the UE 120. The UE 120 can accordingly receive the DM-RS based on the conveyed QCL type. In some examples, each TCI state contains parameters for configuring QCL relationship between one or two RSs and the respective DM-RS ports. For the case of two RSs, the QCL types corresponding to the two RSs can be different regardless of whether the references are to the same RS or different RSs.

Among the above four QCL types, the QCL-typeD represents a spatial QCL (sQCL) relationship, and thus can be used to determine a Rx beam at the UE 120. A TCI state indicating a QCL-typeD can be referred to as a spatial TCI state. For example, at the BS 110 side, in order to signal a sQCL indication, the BS 110 can signal a spatial TCI state among the list of TCI state configurations to the UE 120 via an RRC message, a MAC CE, or a PDDCH for reception of a PDCCH or PDSCH. Based on an RS indicated by the spatial TCI state, the UE 120 can determine a Rx beam or Rx spatial filter. In one example, TCI state signaling for PDCCH reception can be performed in the following way. A TCI state list for PDCCH reception can be signaled to the UE 120 via RRC signaling. In a first scenario, the TCI state list for PDCCH reception includes only one TCI state. Accordingly, the TCI state can be directly applied to a respective PDCCH reception without additional MAC CE signaling. In a second scenario, the TCI state list for PDCCH reception includes more than one TCI states, additional MAC CE signaling is performed to activate a TCI state for a PDCCH reception. In one example, TCI signaling for PDSCH reception can be performed in the following way. A TCI state list for PDSCH reception including one or more TCI states can be configured to the UE 120 via RRC signaling. In a first scenario, a MAC CE activates one TCI state in the configured TCI state list. Accordingly, the activated TCI state is directly applied for a PDSCH reception without additional DCI signaling in a PDCCH scheduling the PDSCH. In a second scenario, a MAC CE activates more than one TCI states in the configured TCI state list. Accordingly, additional DCI signaling in a scheduling PDCCH is used.

FIG. 2 shows an example illustrating reception of downlink data or control transmissions based on sQCL indications signaled from the BS 110 to the UE 120 according to an embodiment. As shown, at time t1, the UE 120 receives a first sQCL indication 210 (e.g., a first spatial TCI state) from the BS 110, for example, via an RRC message, or a MAC CE carried in a PDSCH. For example, the BS 110 selects the Tx beam 118 among the set of Tx beams 136, 116, 146, 156, 118 and 166 of the TRP 112 and the TRP 114 for transmission of a PDCCH 211. Before transmission of the PDCCH 211, the BS 110 can signal the sQCL indication 210 to the UE 120 that indicates the second RS 119. As described, the second RS 119 is used previously to determine the beam pair link over the BS Tx beam 118 and the UE Rx beam 122 based on a previous measurement process using the second RS 119. Based on the sQCL indication 210, the UE 120 can determine to use the Rx beam 122 (instead of the other Rx beams) for the reception of the PDCCH 211 because the Rx beam 122 is previously determined based on the second RS 119.

At time t2, the UE 120 receives a second sQCL indication 220 (e.g., a second spatial TCI state) from the BS 120, for example, carried in a MAC CE, or a PDCCH that schedules a PDSCH 221. For example, the BS 110 selects the Tx beam 116 among the set of Tx beams 136, 116, 146, 156, 118 and 166 of the TRP 112 and the TRP 114 for transmission of the PDSCH 221. Accordingly, the BS 110 can signal the sQCL indication 220 to the UE 120 that indicates the first RS 117. As described, the first RS 117 is used previously to determine the beam pair link over the Tx beam 116 and the Rx beam 121 based on a previous measurement process using the first RS 117. Based on the sQCL indication 220, the UE 120 can determine to use the Rx beam 121 (instead of the other Rx beams) for the reception of the PDSCH 221 because the Rx beam 121 is previously determined based on the first RS 117.

However, the to-be-received control channel PDCCH 211 and data channel PDSCH 221 may overlap with each other in time domain in an embodiment. As shown in FIG. 2, the PDCCH 211 and the PDSCH 221 can be frequency-division multiplexed (FDMed) over a same set of OFDM symbols between the times t4 and t5. As described, the PDCCH 211 and the PDSCH 221 are configured with the QCL indications 210 and 220 indicating two different Rx beams 122 and 121 for reception of the PDCCH 211 and the PDSCH 221, respectively, while the UE 120 is only capable of generating one Rx beam at a time. For example, the PDSCH 221 is scheduled by an earlier PDCCH than the PDCCH 211. However, there is an urgent packet that should be delivered to the UE. The BS 110 cannot wait until the PDSCH 221 is completely transmitted. Thus, it starts to schedule a new PDSCH for that urgent packet using the PDCCH 211 that is transmitted using a different TRP 114. Under such a scenario that two different Rx beams 121 and 122 are indicated or configured for reception of two simultaneously-transmitted channels, the UE 120 can be configured to prioritize the reception of the control channel PDCCH 211 over the data channel PDSCH according to some embodiments. In some examples, the prioritization of a PDCCH over a PDSCH can be based on one or two of the following reasons. First, a PDCCH usually carries information more important than a PDSCH. Second, if a PDSCH is overlapped with a PDCCH, the PDSCH is usually scheduled by an earlier PDCCH. If the BS decides to transmit a newer PDCCH and abandons the PDSCH, it can be assumed that there may be a more important/urgent information in the PDCCH. Third, for a PDSCH that cannot be correctly received by a UE, there can be a HARQ-ACK feedback and retransmission to retrieve the data in the PDSCH. However, there is no such scheme for a PDCCH that is missed by a UE.

For example, in the FIG. 2 example, the UE 120 can be configured to use the Rx beam 122 (or respective Rx spatial filter) to perform a reception during the period between times t4 and t5. As a signal carrying the PDSCH 221 is transmitted towards the UE 120 in a direction along the Rx beam 121 that is different from the Rx beam 122, the signal carrying the PDSCH 221 may be attenuated at the UE 120.

In an embodiment, the UE 120 is configured to receive the PDCCH 211 with the Rx beam 122 from times t3 to t5. For example, the PDCCH 211 can be transmitted over a control resource set (CORESET) 211. A CORESET monitoring occasion can be configured earlier, for example, by an RRC signaling for monitoring the CORESET 211. During the configured monitoring occasion, the UE 120 may search over one or more search spaces of the CORESET 211 to detect and decode the PDCCH 211. The above monitoring and detection operation can be performed while the Rx beam 122 is being used for reception of the respective downlink signal corresponding to the CORESET 211.

For reception of the PDSCH 221, corresponding to the first scenario in FIG. 2 where the starting time of the PDSCH 221 follows the stating time of the PDCCH 211, the UE 120 can be configured to first receive PDSCH 221 with the Rx beam 122 between t4 and t5, and then switch to the Rx beam 121 after the time t5 while continuing the reception of the PDSCH 221 in an embodiment. Alternatively, in an embodiment, the reception of the PDSCH 221 can be performed with the Rx beam 122 without switching to the Rx beam 121. In a second scenario where the starting time of the PDSCH 221 is earlier than the stating time of the PDCCH 211, the UE 120 can be configured to first receive PDSCH 221 with the Rx beam 121, and then switch to the Rx beam 122 when the PDCCH 211 starts in an embodiment. In an embodiment, the PDSCH 221 can be dropped in either the first or the second scenario, and no reception operations are performed.

In the FIG. 1 and FIG. 2 examples, the two simultaneously transmitted PDSCH 221 and PDDCH 211 can be within a same component carrier, or can be distributed over two different component carriers when inter or intra band carrier aggregation scheme is implemented. For example, the two TRPs 112 and 114 can operate in an FDMed manner, and be used for transmission over a same component carrier but corresponding to different frequency ranges in an embodiment, or the two TRPs 112 and 114 can be used for transmissions over two component carriers in another embodiment.

In addition, different from the FIG. 1 example where the two TRPs 112 and 114 are distributed at different locations, in an embodiment, the TRPs 112 and 114 can be located at a same site. Further, in an embodiment, a same TRP is used to perform functions of the two TRPs 112 and 114. For example, two groups of beams can be generated each covering different directions. Although the Tx beams 116 and 118 are transmitted from a same site in the above embodiments, under non-line-of-sight conditions, the UE 120 can receive the respective transmissions from the two different directions of the Tx beams 116 and 118.

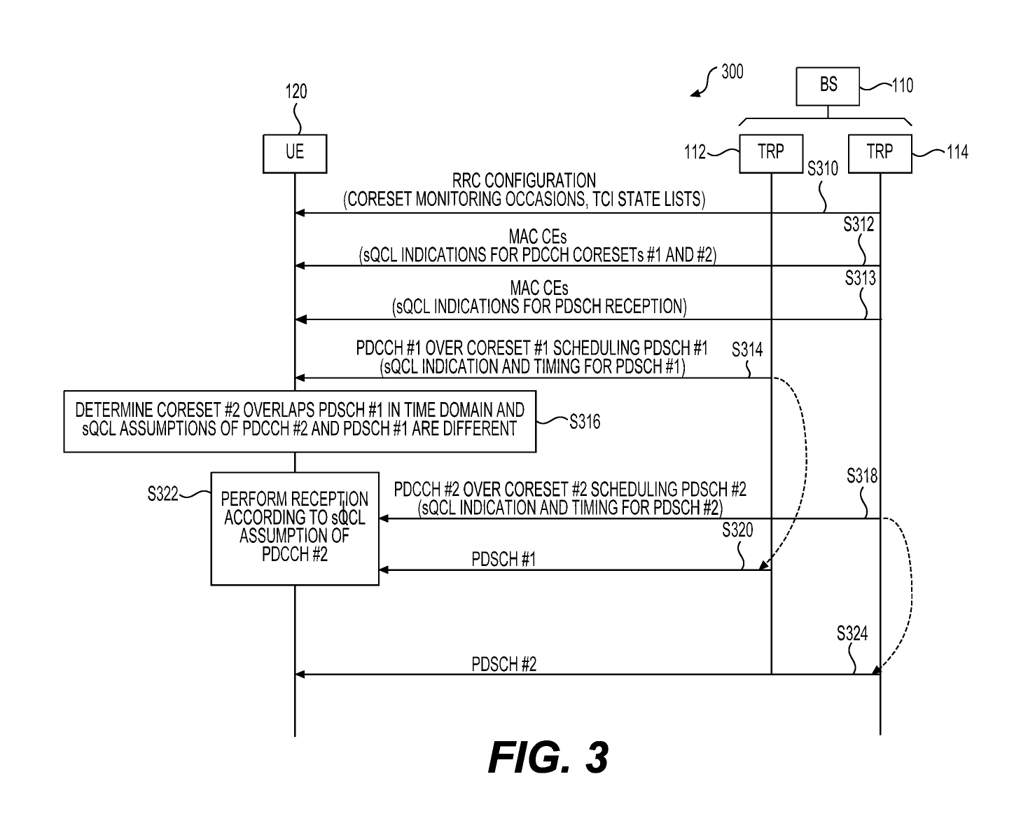

FIG. 3 shows a process 300 for reception of simultaneously transmitted PDCCH and PDSCH that have different sQCL assumptions according to an embodiment of the disclosure. In the process, the reception of the PDCCH is prioritized over the PDSCH, and the reception of the two simultaneously transmitted channels follows the sQCL assumption of the PDCCH. The FIG. 1 example is used as a reference for explanation of the process 300.

At S310, RRC configurations are transmitted from the BS 110 to the UE 120. The RRC configurations may be carried in one or more RRC messages, and may be transmitted from the TRP 112 or 114. The RRC configurations can include a CORESET monitoring occasion configuration that specifies a sequence of CORESET monitoring occasions. Accordingly, the UE 120 can know the timings of the following CORESET transmissions. In addition, the RRC configurations can include a list of TCI state configurations for PDCCH reception and a list of TCI state configurations for PDSCH reception in an embodiment.

At S312, one or more MAC CEs are transmitted from the BS 110 to the UE 120. In one example, two MAC CEs are transmitted, for example, one from the TRP 112 and one from TRP 114. The two MAC CEs may each carry a different or same sQCL indication for reception of a first set of CORESETs transmitted from the TRP 112, and a second set of CORESETs transmitted from the TRP 114, respectively. Based on the received sQCL indication(s) (e.g., TCI states), the UE 120 can obtain sQCL assumptions for monitoring the following CORESET transmissions.

At S313, one or more MAC CEs are transmitted from the BS 110 to the UE 120. In one example, a MAC CE is transmitted to activate or indicate one or more of the TCI states from the RRC configured list for PDSCH reception. In one example, more than one TCI states are activated by the MAC CE, and one of these activated TCI states (e.g., a spatial TCI state) may be indicated for a PDSCH reception at a later time by a PDCCH that scheduling the PDSCH. In one example, only one TCI state (e.g., a spatial TCI state) is activated by the MAC CE, and this activated TCI state is directly applied for a PDSCH reception at a later time. In addition, for receptions of different PDSCHs, different respective MAC CEs can be transmitted.

In the following steps S314 and S318, a first PDCCH #1 over a CORESET #1 and a second PDCCH #2 over a CORESET #2 are successively transmitted from the BS 110 to the UE 120. Based on the information received at the S310 and S312, the UE 110 can know the timings and sQCL assumptions for monitoring the CORESET #1 and the CORESET #2.

At S314, the PDCCH #1 over the CORESET #1 are transmitted from the TRP 112 to the UE 120, for example, over the beam pair of the beams 116 and 121. Based on the previously obtained knowledge of a monitoring occasion and a sQCL assumption, the UE 120 can accordingly perform reception of the PDCCH #1 over the CORESET #1. The PDCCH #1 schedules a PDSCH #1 to be later transmitted at S320. For example, a DCI carried in the PDCCH #1 may provide a sQCL indication (e.g., a TCI state) and timing information (e.g., a resource allocation) for reception of the PDSCH #1. Accordingly, the UE 120 can determine a sQCL assumption and a timing for reception of the PDSCH #1.

In another embodiment, the PDSCH #1 can be one of a set of PDSCHs that are semi-persistently scheduled (SPS). Accordingly, the timing for reception of the SPS-PDSCH #1 can be determined in a different manner. For example, an RRC configuration may be received from the BS 110 at the UE 120 (e.g., at S310) that defines a sequence of periodically transmitted SPS-PDSCHs. For example, the RRC configuration may indicate a periodicity of the transmission of the SPS-PDSCHs. A PDCCH (e.g., the PDCCH #1) the can be used to activate or deactivate the transmission of the sequence of SPS-PDSCHs, and indicate resource allocation of the respective SPS-PDSCHs in time domain and frequency domain for reception of the respective SPS-PDSCHs. For example, when such a PDCCH, the PDCCH #1, for activating the SPS-PDSCHs is received at the S314, the UE 120 can determine that the SPS-PDSCHs would be transmitted periodically according to a periodicity configured by the RRC configuration. Therefore, the timing of the SPS-PDSCH #1 can be determined based on both the PDCCH #1 received at S314 and the RRC configuration received at S310.

In an embodiment, when determining a sQCL assumption for reception of the PDSCH #1, the UE 120 may adopt different methods depending on a time offset between the reception of the PDCCH #1 and the reception of the PDSCH #1. For example, when the time offset is smaller than a threshold, in a first embodiment, the UE 120 may use the sQCL assumption for reception of the PDCCH #1 (that is indicated by the sQCL indication carried in a MAC CE at S312) as the sQCL assumption for reception of the PDSCH #1. For example, when the time offset is smaller than a threshold, the UE 120 may not have enough time to decode the information of the sQCL indication carried in the PDCCH #1, thus the UE 120 may adopt the sQCL assumption of the PDCCH #1 for receiving the respective PDSCH #1. When the time offset is smaller than a threshold, in a second embodiment, the UE 120 may use a sQCL assumption for reception of a PDCCH in a CORESET with the lowest CORESET-ID in a latest slot. For example, in the latest slot, there can be one or more CORESETs within an active bandwidth part (BWP) of a serving cell that are being monitored by the UE. Therefore, the sQCL assumption of the CORESET with the lowest CORESET-ID can be used for reception of the PDSCH #1. The CORESET with the lowest CORESET-ID may not be the CORESET #1 carrying the PDCCH #1 that schedules the PDSCH #1. When the time offset is greater or equal to the threshold, the UE 120 may use the sQCL indication carried in the PDCCH #1 to determine a sQCL assumption for receiving the PDSCH #1.

At S316, the UE 120 determines whether the CORESET #2 overlaps the PDSCH #1 in time domain according to the knowledge of monitoring occasion of the CORESET #2, and the timing of the PDSCH #1. The UE 120 also determines whether the sQCL assumptions of the CORESET #2 and the PDSCH #1 are different according to previously obtained knowledge. When the CORESET #2 overlaps the PDSCH #1 in time domain, and the sQCL assumptions of the PDCCH #2 and the PDSCH #1 are different, the UE 120 may determine to prioritize the reception of the PDCCH #2 over the PDSCH #1, and use the sQCL assumption of the PDCCH #2 to perform the reception. For example, the Rx beam 122 can be used according to the second RS 119 indicated by the sQCL assumption for receiving the PDCCH #2 instead of the Rx Beam 121.

At S318, the PDCCH #2 scheduling a PDSCH #2 can be transmitted over the CORESET #2 from the TRP 114 to the UE 120. The PDCCH #2 may carry information of a sQCL indication and a timing for receiving the PDSCH #2.

At S320, the PDSCH #1 is transmitted from the TRP 112 to the UE 120. The PDSCH #1 is FDMed with the PDCCH #2, and overlaps the PDCCH #2 over at least one OFDM symbol.

At S322, the UE 120 may perform a reception of the PDCCH #2 and the PDSCH #1 according to the sQCL assumption of the PDCCH #2. For example, the sQCL assumption of the PDCCH #2 indicates the second RS 119. As the Rx beam 122 towards the Tx beam 118 from the TRP 114 is associated with the second RS 119 (obtained based on a measurement of the second RS 119), the UE 120 may accordingly employ the Rx beam 122 for reception of the PDCCH #2.

At S324, the PDSCH #2 is transmitted from the TRP 114 to the UE 120. The UE 120 may receive the PDSCH #2 using sQCL information and resource allocation information carried in or associated with the PDCCH #2.

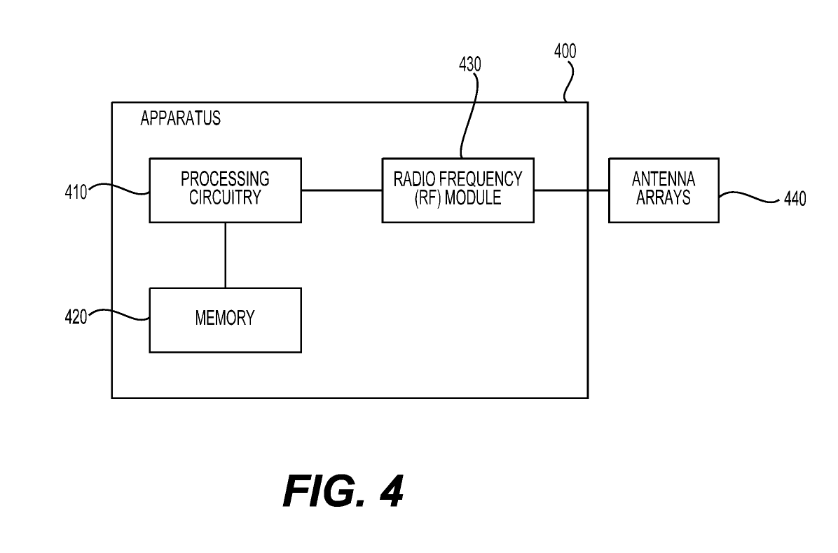

FIG. 4 shows an exemplary apparatus 400 according to embodiments of the disclosure. The apparatus 400 can be configured to perform various functions in accordance with one or more embodiments or examples described herein. Thus, the apparatus 400 can provide means for implementation of techniques, processes, functions, components, systems described herein. For example, the apparatus 400 can be used to implement functions of the UE 110 or a combination of the BS 110 and the TRPs 112 and 114 in various embodiments and examples described herein. The apparatus 400 can include a general purpose processor or specially designed circuits to implement various functions, components, or processes described herein in various embodiments. The apparatus 400 can include processing circuitry 410, a memory 420, and a radio frequency (RF) module 430.

In various examples, the processing circuitry 410 can include circuitry configured to perform the functions and processes described herein in combination with software or without software. In various examples, the processing circuitry 410 can be a digital signal processor (DSP), an application specific integrated circuit (ASIC), programmable logic devices (PLDs), field programmable gate arrays (FPGAs), digitally enhanced circuits, or comparable device or a combination thereof

In some other examples, the processing circuitry 410 can be a central processing unit (CPU) configured to execute program instructions to perform various functions and processes described herein. Accordingly, the memory 420 can be configured to store program instructions. The processing circuitry 410, when executing the program instructions, can perform the functions and processes. The memory 420 can further store other programs or data, such as operating systems, application programs, and the like. The memory 420 can include a read only memory (ROM), a random access memory (RAM), a flash memory, a solid state memory, a hard disk drive, an optical disk drive, and the like.

The RF module 430 receives a processed data signal from the processing circuitry 410 and converts the data signal to beamforming wireless signals that are then transmitted via antenna arrays 440, or vice versa. The RF module 430 can include a digital to analog convertor (DAC), an analog to digital converter (ADC), a frequency up convertor, a frequency down converter, filters and amplifiers for reception and transmission operations. The RF module 430 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 440 can include one or more antenna arrays.

In an embodiment, the antenna arrays 440 and part or all functions of the RF module 430 are implemented as one or more TRPs, and the remaining functions of the apparatus 400 are implemented as a BS. Accordingly, the TRPs can be co-located with such a BS, or can be deployed away from the BS.

The apparatus 400 can optionally include other components, such as input and output devices, additional or signal processing circuitry, and the like. Accordingly, the apparatus 400 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a configuration specifying a control resource set (CORESET) monitoring occasion of a first physical downlink control channel (PDCCH) at a user equipment (UE);
receiving a second PDCCH scheduling or activating transmission of a physical downlink shared channel (PDSCH) at the UE;
determining whether the PDSCH overlaps the first PDCCH in time domain;
determining whether a first spatial quasi-co-location (sQCL) assumption for reception of the first PDCCH and a second sQCL assumption for reception of the PDSCH are different; and
prioritizing the reception of the first PDCCH when the PDSCH overlaps the first PDCCH in time domain and the first and second sQCL assumptions are different.

2. The method of claim 1, wherein prioritizing the reception of the first PDCCH includes:
performing the reception of the first PDCCH according to the first sQCL assumption for reception of the first PDCCH.

3. The method of claim 2, wherein performing the reception of the first PDCCH according to the first sQCL assumption includes:
monitoring a CORESET carrying the first PDCCH using a spatial filter associated with a reference signal (RS) indicated by the first sQCL assumption.

4. The method of claim 1, wherein the first sQCL assumption is determined based on a transmission configuration indication (TCI) state carried in a radio resource control (RRC) message or a MAC control element (CE).

5. The method of claim 1, wherein the second sQCL assumption is determined based on a TCI state carried in a MAC CE or a second PDCCH scheduling the PDSCH.

6. The method of claim 1, wherein determining whether the PDSCH overlaps the first PDCCH in time domain includes:
determining whether the PDSCH overlaps the first PDCCH in time domain according to the received configuration specifying the CORESET monitoring occasion of the first PDCCH and the received second PDCCH scheduling the transmission of the PDSCH, or according to the received configuration specifying the CORESET monitoring occasion of the first PDCCH and the second PDCCH and a second configuration received at the UE specifying a periodicity of a sequence of semi-persistently scheduled (SPS) PDSCHs that includes the PDSCH activated by the second PDCCH.

7. The claim of claim 1, further comprising:
when a time offset between reception of the second PDCCH and reception of the PDSCH is smaller than a threshold, using a sQCL assumption for the reception of a PDCCH, that is carried in a CORESET with the lowest CORESET-ID in a latest slot in which one or more CORESETs within an active bandwidth part (BWP) of a serving cell are monitored by the UE, as the second sQCL assumption for reception of the PDSCH, and
when the time offset between the reception of the second PDCCH and the reception of the PDSCH is greater than or equal to the threshold, using a sQCL assumption indicated by a second sQCL indication carried in the second PDCCH as the second sQCL assumption for the reception of the PDSCH.

8. The method of claim 1, wherein the first PDCCH and the PDSCH are transmitted over two different component carriers in an intra-band carrier aggregation configuration, or over a same component carrier.

9. A user equipment (UE), comprising circuitry configured to:
receive a configuration specifying a control resource set (CORESET) monitoring occasion of a first physical downlink control channel (PDCCH) at a user equipment (UE);
receive a second PDCCH scheduling or activating transmission of a physical downlink shared channel (PDSCH) at the UE;
determine whether the PDSCH overlaps the first PDCCH in time domain;
determine whether a first spatial quasi-co-location (sQCL) assumption for reception of the first PDCCH and a second sQCL assumption for reception of the PDSCH are different; and
prioritize the reception of the first PDCCH when the PDSCH overlaps the first PDCCH in time domain and the first and second sQCL assumptions are different.

10. The UE of claim 9, wherein the circuitry is further configured to:
perform the reception of the first PDCCH according to the first sQCL assumption for reception of the first PDCCH.

11. The UE of claim 10, wherein the circuitry is further configured to:
monitor a CORESET carrying the first PDCCH using a spatial filter associated with a reference signal (RS) indicated by the first sQCL assumption.

12. The UE of claim 9, wherein the first sQCL indication is a transmission configuration indication (TCI) state carried in a radio resource control (RRC) message or a MAC control element (CE).

13. The UE of claim 9, wherein the second sQCL assumption is determined based on a TCI state carried in a MAC CE or a second PDCCH scheduling the PDSCH.

14. The UE of claim 9, wherein the circuitry is further configured to:
determine whether the PDSCH overlaps the first PDCCH in time domain according to the received configuration specifying the CORESET monitoring occasion of the first PDCCH and the received second PDCCH scheduling the transmission of the PDSCH, or according to the received configuration specifying the CORESET monitoring occasion of the first PDCCH and the second PDCCH and a second configuration received at the UE specifying a periodicity of a sequence of semi-persistently scheduled (SPS) PDSCHs that includes the PDSCH activated by the second PDCCH.

15. The UE of claim 9, wherein the circuitry is further configured to:
when a time offset between reception of the second PDCCH and reception of the PDSCH is smaller than a threshold, use a sQCL assumption for the reception of a PDCCH, that is carried in a CORESET with the lowest CORESET-ID in a latest slot in which one or more CORESETs within an active bandwidth part (BWP) of a serving cell are monitored by the UE, as the second sQCL assumption for reception of the PDSCH; and
when the time offset between the reception of the second PDCCH and the reception of the PDSCH is greater than or equal to the threshold, use a sQCL assumption indicated by a second sQCL indication carried in the second PDCCH as the second sQCL assumption for the reception of the PDSCH.

16. The UE of claim 9, wherein the first PDCCH and the PDSCH are transmitted over two different component carriers in an intra-band carrier aggregation configuration, or over a same component carrier.

17. A non-transitory computer-readable medium storing instructions that, when executed by processing circuitry, cause the processing circuitry to perform a method, the method comprising:
receiving a configuration specifying a control resource set (CORESET) monitoring occasion of a first physical downlink control channel (PDCCH);
receiving a second PDCCH scheduling or activating transmission of a physical downlink shared channel (PDSCH);
determining whether the PDSCH overlaps the first PDCCH in time domain;
determining whether a first spatial quasi-co-location (sQCL) assumption for reception of the first PDCCH and a second sQCL assumption for reception of the PDSCH are different; and
prioritizing the reception of the first PDCCH when the PDSCH overlaps the first PDCCH in time domain and the first and second sQCL assumptions are different.

18. The non-transitory computer-readable medium of claim 17, wherein prioritizing the reception of the first PDCCH carried in the CORESET includes:
performing the reception of the first PDCCH according to the first sQCL assumption for reception of the first PDCCH.

19. The non-transitory computer-readable medium of claim 17, wherein the method further comprises:
determining whether the PDSCH overlaps the first PDCCH in time domain according to the received configuration specifying the CORESET monitoring occasion of the first PDCCH and the received second PDCCH scheduling the transmission of the PDSCH, or according to the received configuration specifying the CORESET monitoring occasion of the first PDCCH and the second PDCCH and a second configuration received at the UE specifying a periodicity of a sequence of semi-persistently scheduled (SPS) PDSCHs that includes the PDSCH activated by the second PDCCH.

20. The non-transitory computer-readable medium of claim 17, wherein the method further comprises:
when a time offset between reception of the second PDCCH and reception of the PDSCH is smaller than a threshold, using a sQCL assumption for the reception of a PDCCH, that is carried in a CORESET with the lowest CORESET-ID in a latest slot in which one or more CORESETs within an active bandwidth part (BWP) of a serving cell are monitored by the UE, as the second sQCL assumption for reception of the PDSCH, and
when the time offset between the reception of the second PDCCH and the reception of the PDSCH is greater than or equal to the threshold, using a sQCL assumption indicated by a second sQCL indication carried in the second PDCCH as the second sQCL assumption for the reception of the PDSCH.
